(19) United States
(12) Patent Application Publication
(10) Pub. No.: US 2007/0209535 A1
(43) Pub. Date: Sep. 13, 2007

(54) Printing Screen Sealing System

(76) Inventors: Chris J. Quilling, Hudson, WI (US); Michael S. Cummings, Luck, WI (US)

Correspondence Address: WESTMAN CHAMPLIN & KELLY, P.A., SUITE 1400, 900 SECOND AVENUE SOUTH, MINNEAPOLIS, MN, 55402-3319, US

(21) Appl. No.: 11/660,710

(22) PCT Filed: Feb. 13, 2006
(86) PCT No.: PCT/US06/04980

§ 371 Date: Feb. 21, 2007

Related U.S. Application Data
(60) Provisional application No. 60/652,649, filed on Feb. 14, 2005.

(51) Int. Cl. B05C 17/08

(52) U.S. Cl. 101/127.1

(57) ABSTRACT

A system providing a seal between an inner rim of a support frame and a screen supported by the support frame. A bead of flow dam material is applied at the juncture of the inner rim of the support frame and the screen. The flow dam material seals to the inner rim and to the printing screen. The flow dam material comprises a material which is semiliquid upon application and cures to form a bead of resilient material that does not dissolve in the presence of inks and solvents used in printing and reclamation.

### CROSS-REFERENCE TO RELATED APPLICATION

This application is a National Stage Application of International patent application No. PCT/US2006/004980, filed Feb. 13, 2006, and published in English as WO 2006/088777 A2, and which claims the benefit of U.S. provisional patent application Ser. No. 60/652,649, filed Feb. 14, 2005.

### FIELD OF THE INVENTION

The present invention relates to screen printing and more particularly but not by way of limitation to a system of sealing an intermediate screen mesh region between a frame and an emulsion or blockout material.

### SUMMARY OF THE INVENTION

Disclosed is a screen printing system providing a seal between an inner rim of a support frame and a screen mesh supported by the support frame. A bead of flow dam material is applied at the juncture of the inner rim seam of the support frame where the frame edge and the mesh come together. The flow dam material seals to the inner rim and to the printing screen mesh. The flow dam material comprises a material which is semiliquid upon application and which cures to form a bead of material that does not dissolve in the presence of reclamation solvents or printing inks.

### BRIEF DESCRIPTION OF THE DRAWINGS

FIG. 1 illustrates a portion of a state-of-the-art printing screen.

FIG. 2 illustrates a partial view of a printing screen which is sealed without the use of tape as a sealant.

FIG. 3 illustrates a partial cross-sectional view of a portion of a printing screen which is sealed without the use of tape as a sealant.

### DETAILED DESCRIPTION OF ILLUSTRATIVE EMBODIMENTS

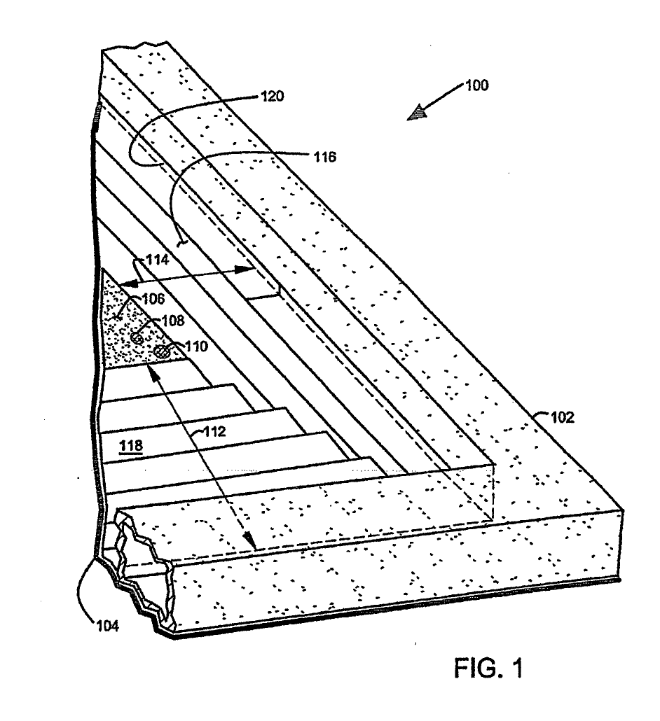

FIG. 1 illustrates a portion of a state-of-the-art printing screen 100. Printing screen 100 is typically rectangular is shape and comprises a rectangular peripheral outer support frame 102 formed of aluminum tube that attaches to and supports an outer rim of a screen 104. The screen 104 is typically lightly stretched or under tension, and is formed of woven nylon, silk, polyester, stainless steel wire or other material, depending on the application. The screen 104 is porous to allow ink or dye to flow through the screen 104 from a top (squeegee) side to a bottom (substrate) side of the screen 104 during a screen printing process.

A thin emulsion layer 106 is applied in a central region of the screen 104. The emulsion layer 106 is not continuous, but is interrupted by openings 108, 110 where the emulsion has been removed to expose the screen 104. The openings 108, 110 define a graphic image that is to be printed. The emulsion layer 106 is typically a photosensitive emulsion and the openings 108, 110 are formed during a development step when emulsion is washed away after the emulsion layer 106 is exposed to a bright light that passes through a black/clear image exposure film (not illustrated). The exposure film is typically a 1:1 size in direct contact with the emulsion layer 106 during the exposure. The image can be applied by digital transfer artwork film, through inkjet image spraying, wax image spraying, digital light imaging, camera film contacting or Rubylith film image plotter cutting. Alternatively, an image can be projected onto the emulsion using a graphic arts camera. A negative or positive image may be used for the exposure depending on the particular process characteristics of the photographic emulsion that is used.

During a production printing process, ink or dye is forced through the openings 108, 110 by using a squeegee (not illustrated). The squeegee is used to draw a bead of viscous ink or dye (not illustrated) across the illustrated top (squeegee) side of the emulsion layer 106. An article to be printed (substrate) is place under the printing screen 100 and receives the ink or dye that is forced through the openings 108, 110. The screen is used repeatedly to make multiple printed articles in a production process. Articles to be printed can include fabric articles such as shirts, hats, curtains, metal articles, plastic articles and a variety of other articles requiring images. Images may be subjected to color separation, and multiple printing screens 100 may be used sequentially to apply multiple ink colors to the same article. Alternatively, multiple spot color screens for different colors can be used.

Intermediate regions 112, 114 of the screen 104 between the emulsion layer 106 and the frame 102 are masked with strips of tape 116, 118 in an effort to seal the intermediate regions 112, 114 and reduce ink leakage. The strips of tape 116, 118 have an adhesive backing. The strips of tape 116, 118 overlap one another and also overlap the emulsion layer 106 in an effort to obtain a seal. The strips of tape 116, 118 also overlap the frame 102 at 120 to obtain an imperfect seal to the frame 102. The masking with tapes 116, 118 reduces accidental leakage of ink or dye through the intermediate regions 112, 114. Accidental leakage of ink or dye can damage articles being printed, and sometimes occurs during the production process, requiring repairs of the tape. The frame 102, the emulsion layer 106 and the tapes 116, 118 form an imperfectly sealed well for ink or dye, and the ink or dye can be forced out of the well at precise locations defined by the openings 108 to form an ink or dye graphic image on a substrate.

After completion of a production printing run, the printing screen 100 is run through a reclamation process so that the screen is ready for reuse with a different graphic image. A reclamation process is selected that cleans the printing screen 100 of ink, dye, emulsion layer 106 and tapes 116, 118. Solvents and temperatures need to be selected for reclamation that will remove undesired materials without damaging the frame 102 or screen 104, and without loosening the adhesive attaching the screen 104 to the frame 102. Reclamation is a time consuming and expensive process. Removal of the tapes 116, 118 and especially tape adhesive residues is particularly difficult and expensive, and often involves removal by hand in order to ensure thorough removal without damaging the screen 104.

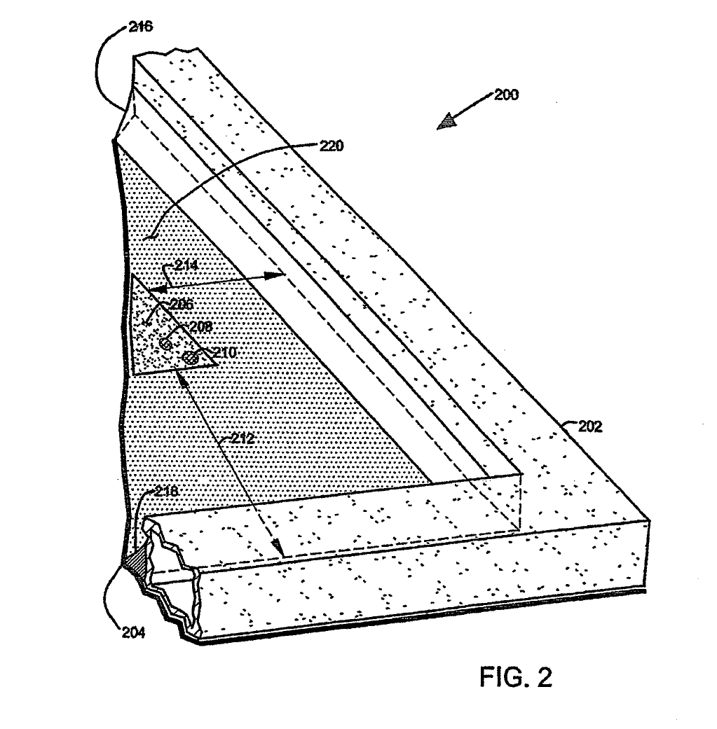

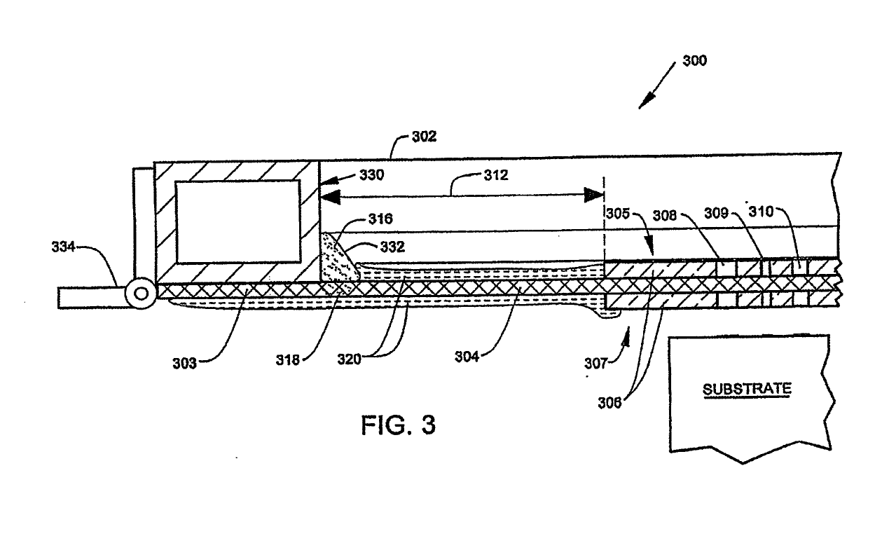

A method and apparatus are needed that will provide masking of the intermediate regions 112, 114 between an emulsion layer 106 and a frame 102, while avoiding the costly and time consuming process of applying and removing the tapes 116, 118. As described below in connection with FIGS. 2-3, printing screens and methods of making and cleaning printing screens are disclosed in which the use of tape as a sealant has been eliminated.

FIG. 2 illustrates a partial view of a printing screen 200 which is sealed without the use of tape as a sealant. The printing screen 200 comprises a peripheral outer support frame 202 that attaches to and supports an outer rim of a screen 204. The screen 204 is a porous fabric, which can be woven or non-woven fabric through which ink or dye can be forced. The screen 204 is porous to allow ink or dye to flow through the screen 204 from a top (squeegee) side to a bottom (substrate) side of the screen 204 during a screen printing production process.

A thin emulsion layer 206 is applied in a central region of the screen 204. The emulsion layer 206 is typically rectangular, and only a portion of the emulsion layer 206 is visible in FIG. 2. The emulsion layer 206 is not continuous, but is interrupted by openings 208, 210 where the emulsion has been removed to expose the screen 204. The openings 208, 210 define a graphic image that is to be printed. The emulsion layer 206 is typically a photosensitive emulsion as described above in connection with FIG. 1.

Intermediate regions 212, 214 between the emulsion layer 206 and the frame 202 are sealed with a bead of flow dam material at 216, 218 and a layer of block out coating 220. The bead of flow dam material 216, 218 runs in a continuous bead around an inside rim of the frame 202. The bead of flow dam material at 216, 218 overlaps the frame 202 and the screen 204 to obtain a seal. The block out coating 220 fills the screen 204 between the emulsion layer 206 and the flow dam material 216, 218 to form a seal. Emulsion material can also be used as a blockout material with either secondary light exposure to harden the emulsion material, or to coat emulsion overlapping the edge of the flow dam material prior to initial exposure of the image emulsion. The block out coating 220 can be a conventional block out coating is applied in a continuous loop on the screen 204 around the emulsion layer 206. The flow dam material 216, 218 and the block out coating 220 prevent accidental leakage of ink or dye through the intermediate regions 212, 214.

After completion of a production printing run, the printing screen 200 is run through a reclamation process so that the screen is ready for reuse with a different graphic image. A reclamation process is selected that cleans the printing screen 200 of ink, dye, emulsion layer 206 and block out coating 220. The flow dam material 216, 218, however, is selected so that the reclamation process does not remove the flow dam material 216, 218. The flow dam material 216, 218 is permanent and survives multiple cycles of production printing and reclamation without having to be replaced. Solvents and temperatures are selected for reclamation that will remove undesired materials without damaging the frame 202, the screen 204, or the flow dam material 216, 218, and without loosening the adhesive attaching the screen 204 to the frame 202. The bead of flow dam material does not dissolve in the presence of ink/dye solvent, blockout solvent and screen recovery solvent.

Reclamation is greatly simplified because there is no adhesive tape present that requires removal. There is no danger of damaging the screen 204 by use of mechanical tools to remove adhesive tape and residual adhesive left by the tapes. As described in more detail below in connection with FIG. 3, the bead of flow dam material 216, 218 is shaped to provide a reliable seal.

FIG. 3 illustrates a cross-sectional view of a portion of a printing screen 300 which is sealed without the use of tape as a sealant. A printing screen 300 comprises a rectangular peripheral outer support frame 302 that attaches to and supports an outer rim 303 of a screen 304. The outer rim 303 can be attached to the support frame 302 by adhesive or by other known attachment methods. The screen is in slight tension so that it rests in a flat position, but can be deflected slightly by a squeegee during production. The screen 304 is a porous fabric, which can be woven or non-woven fabric through which ink or dye can be forced by a squeegee. The screen 304 is porous to allow ink or dye to flow through the screen 304 from a top (squeegee) side 305 to a bottom (substrate) side 307 of the screen 304 during a screen printing process.

A thin emulsion layer 306 is applied in a central region of the screen 304. The emulsion layer 306 typically flows through the screen during application and, as illustrated, is present on both the squeegee side 305 and the substrate side 307. The emulsion layer 306 is not continuous, but is interrupted by openings 308, 309, 310 where the emulsion has been removed to expose the screen 304. The openings 308, 309, 310 define a graphic image that is to be printed. The emulsion layer 306 is typically a photosensitive emulsion as described above in connection with FIG. 1.

Intermediate region 312 between the emulsion layer 306 and the frame 302 is sealed with a bead of flow dam material 316 and a layer of block out coating 320. As illustrated, the block out coating 320 typically flows through the screen during application and is on both the squeegee side 305 and the substrate side 307 of the screen 304. The bead of flow dam material 316 overlaps the frame 302 and the screen 304 to obtain a seal. The flow dam material 316 flows through the screen 304 at 318 during application as illustrated. The block out coating 320, which is applied after the flow dam material 316 has cured, fills the screen 304 between the emulsion layer 306 and the flow dam material 316 to form a seal. The flow dam material 316 and the block out coating 320 prevent accidental leakage of ink or dye through the intermediate regions 312.

After completion of a production printing run, the printing screen 300 is run through a reclamation process so that the screen is ready for reuse with a different graphic image in a fresh layer of emulsion. A reclamation process is selected that cleans the printing screen 300 of ink, dye, emulsion layer 306 and block out coating 320. The flow dam material 316, however, is selected so that the reclamation process does not remove the flow dam material 316. The flow dam material 316 is permanent and survives multiple cycles of production printing and reclamation without having to be replaced. Solvents and temperatures are selected for reclamation that will remove undesired materials without damaging the frame 302, the screen 304, or the flow dam material 316 and without loosening the adhesive attaching the screen 304 to the frame 302. Reclamation is greatly simplified because there is no adhesive tape present that requires removal during a later reclamation process. There is no danger of damaging the screen 304 by use of mechanical tools to remove adhesive tape.

The bead of flow dam material 316 is shaped to provide a reliable seal. The flow dam material 316 extends up a vertical side 330 of the frame 302 to provide a long vertical sealing length. The flow dam material 316 extends through the screen 304 at 318 to form a reliable seal to the screen. The flow dam material 316 has a beveled upper surface 332 so that block out coating 320 can overlay the flow dam material 318 to form a reliable seal. When fully cured, the flow dam material 316 is resilient and bendable so that flexing of the screen 304 due to the force of the squeegee or flexing of the frame 302 due to movement of the frame 302 on a hinge 334 does not crack the seals made to the flow dam material 316.

The flow dam material 216, 218, 316 is applied in a viscous, semi-liquid form and is subsequently cured into a resilient finished material. While still in the viscous, semi-liquid form, the flow dam material 216, 218, 316 can be applied and shaped to the desired bead shape around the inner rim of the frame. While still in the viscous, semi-liquid form, the flow dam material 216, 218, 316 can be forced through openings in a screen to form a seal such as illustrated at 318 in FIG. 3.

The composition of the flow dam material 216, 218, 316 is selected so that the fully cured finished material is not significantly eroded by any of the inks or other chemicals used in the screen printing production process and the reclamation process. Compositions from the urethane family, polyurethane family or silicone family can be used for flow dam material 216, 218, 316, depending on the particular emulsion chemistry, block out chemistry, ink or dye chemistry and cleaning fluid chosen by the user in a particular screen printing shop. Curing processes of the flow dam material 216, 218, 316 depend on the particular flow dam material selected, and can include moisture curing, polymerization, evaporation of solvents, heat curing, ultraviolet curing, radio frequency curing, electrostatic charge curing, infrared light or heat curing, taken singly or in combination, and other known curing processes. In one embodiment, the flow dam material 216, 218, 316 comprises a moisture cured polyurethane that is extruded using a caulk gun. Such a moisture cured, polyurethane is available as Tremco Vulkem® 921 from Tremco Inc. in Cleveland, Ohio, USA. Moisture-cured polyurethanes, once cured, resist erosion by a wide variety of cleaning solvents and temperature ranges encountered in screen reclamation processes.

With conventional use of tape to seal frame edges, ink or dye leaks into the edge seams (such as region 303 in FIG. 3) and extensive efforts are required during reclamation to decontaminate such regions. With the use of flow dam material 216, 218, 316, seepage into edge seams is eliminated. With the use of the processes and printing frames described above in connection with FIGS. 2-3, significant production and reclamation cost savings can be made in comparison with the costs associated with conventions tape sealing methods.

Although the present invention has been described with reference to preferred embodiments, workers skilled in the art will recognize that changes may be made in form and detail without departing from the spirit and scope of the invention.

What is claimed is:

1. A system providing a seal between an inner rim of a support frame and a screen supported by the support frame, comprising:
a bead of flow dam material applied at the juncture of the inner rim of the support frame and the screen, the flow dam material sealing to the inner rim and to the screen, the flow dam material comprising a material which is semiliquid upon application and cures to form a bead of resilient material that does not dissolve in the presence of reclamation solvents.

2. The system of claim 1 wherein the flow dam material comprises urethane.

3. The system of claim 1 wherein the flow dam material comprises silicone.

4. The system of claim 1 wherein the flow dam material comprises polyurethane.

5. The system of claim 1 wherein the polyurethane comprises a moisture-cured polyurethane.

6. The system of claim 1 and further comprising a layer of blockout coating on the screen and extending between the bead of flow dam material and an emulsion layer on the screen.

7. The system of claim 6 wherein the bead of flow dam material comprises a beveled upper surface.

8. The system of claim 1 wherein the bead of flow dam material comprises a viscous semi-liquid prior to curing and comprises a resilient material after curing.

9. The system of claim 8 wherein the curing comprises moisture curing.

10. The system of claim 1 wherein the bead of flow dam material extends through the screen.
